(19) United States
(12) Patent Application Publication
(10) Pub. No.: US 2007/0018797 A1
(43) Pub. Date: Jan. 25, 2007

(54) Vehicle security system

(75) Inventors: Kuo-Rong Chen, Panchiao City (TW); Chun-Chung Lee, Taipei (TW); Cheng-Hung Huang, KuanNan Village (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/335,666

(22) Filed: Jan. 20, 2006

(30) Foreign Application Priority Data
Jul. 21, 2005 (TW) 094124670

(51) Int. Cl. B60Q 1/00

(52) U.S. Cl. 340/425.5

(57) ABSTRACT

Disclosed is a vehicle security system, which uses a detection circuit to detect the supply of electric power from the car battery to the in-car computer and the status of the car ignition switch, and to start a backup power supply for the in-car computer, and drives the in-car computer to send an informing message to a remote receiver via a wireless communication module when the supply of electric power from the car battery to the in-car computer is terminated or when the car ignition switch is switched on during the alert mode of the vehicle security system.

### BACKGROUND OF THE INVENTION

1. Field of the Invention

The present invention relates to a vehicle security system and more particularly, to such a vehicle security system, which is equipped with a backup power supply and a power detection circuit.

2. Description of Related Art

A conventional vehicle security system is known comprising a security controller electrically connected to the car battery to obtain the necessary working voltage, a buzzer electrically connected to the car battery and the security controller, and a set of sensors installed in the vehicle at different locations and electrically connected to the security controller. When one sensor detects an abnormal condition (for example, the vibration sensor detects a heavy vibration when the car is moved) after the security system has been activated, the respective sensor immediately provides a signal to the security controller, causing the security controller to drive on the buzzer to buzz and the lights of the car to flash.

However, a thief may disconnect the electrical circuit between the car battery and the security controller and other vehicle devices (such as the buzzer and the like) before stealing the car. When the connection between the car battery and the security controller is interrupted, the security controller becomes unable to function, i.e., the security controller is unable to drive the buzzer and the lights of the car at this time.

### SUMMARY OF THE INVENTION

The present invention has been accomplished under the circumstances in view. According to the present invention, the vehicle security system comprises a car battery for the supply of electric power, a security controller, an in-car computer, and a wireless communication module. The security controller is electrically connected to the car battery and alternatively set between an alert mode and a non-alert mode. The in-car computer is electrically connected to the car battery and includes a detection circuit and a backup power supply. Further, the detection circuit detects the supply of electric power from the car battery when the security controller set in the alert mode. The backup power supply provides backup power to the in-car computer and the in-car computer controls the wireless communication module to send an informing message to at least one remote receiver when the supply of electric power from the car battery to the in-car computer is interrupted and the interruption is detected by the detection circuit. Therefore, the vehicle security system can still work normally and call the owner of the car when the car battery power supply is interrupted during the alert mode of the vehicle security system.

The aforesaid informing message can be a short message, a recorded voice message, a multimedia video file, an e-mail message, or any of a variety of other equivalent messages that can be sent wirelessly through the wireless communication module.

The detection circuit further detects the transmission of an ignition switched-on signal from the car ignition switch to the in-car computer during the alert mode, and drives the in-car computer to send the informing message to the at least one remote receiver via the wireless communication module when the transmission of the ignition switched-on signal from the ignition switch to the in-car computer has been detected. The security controller has at least one sensor electrically connected thereto and adapted to provide a detection signal to the security controller when the supply of electric power from the car battery is interrupted. The in-car computer further comprises a storage unit, which has stored therein a number of anti-thief events to be selectively contained in the informing message for sending by the wireless communication module to the at least one remote receiver upon the presence of the detection signal and receipt of the detection signal by the security controller.

The in-car computer further comprises switch device electrically connected to the detection circuit and the backup power supply, and adapted to control the supply of backup power from the backup power supply to the in-car computer. The detection circuit provides a detection signal to the switch device of the in-car computer when the condition that the supply of electric power from the car battery is interrupted has been detected, driving the backup power supply to provide the backup power to the in-car computer.

The aforesaid backup power supply can be a rechargeable battery. The rechargeable battery can be a nickel hydrogen battery, a Li-ion battery, a nickel chrome battery, or a lithium polymer battery. Further, the backup power supply can be an uninterrupted power supply.

### BRIEF DESCRIPTION OF THE DRAWINGS

FIG. 1 is a block diagram showing the architecture of a vehicle security system according to the present invention.

FIG. 2a is a schematic drawing showing the normal status under the alert mode according to the present invention.

FIG. 2b is a schematic drawing showing an abnormal status under the alert mode according to the present invention.

FIG. 3a is a schematic drawing showing the connected normal status of the main power according to the present invention.

FIG. 3b is a schematic drawing showing the disconnected abnormal status of the main power according to the present invention.

FIG. 4 is a schematic drawing showing the storage arrangement of the storage unit.

FIGS. 5a˜5d show different informing message contents according to the present invention.

### DETAILED DESCRIPTION OF THE PREFERRED EMBODIMENT

The present invention provides a vehicle security system, which uses a detection circuit to detect the connection between the car battery and the in-car computer and the production of an Ignition switched-on signal at the ignition switch. When the disconnection status between the car battery and the in-car computer is detected, the detection circuit immediately starts a backup power supply, for enabling the in-car computer to send an informing message to a remote receiver through a wireless communication module so that the car owner or the call center can obtain the informing message in good time. Further, if the detection circuit detects the production of an Ignition switched-on signal under the normal alert mode of the vehicle security system, the in-car computer will also send an informing message to the remote receiver through the wireless communication module, assuring high security of the vehicle security system.

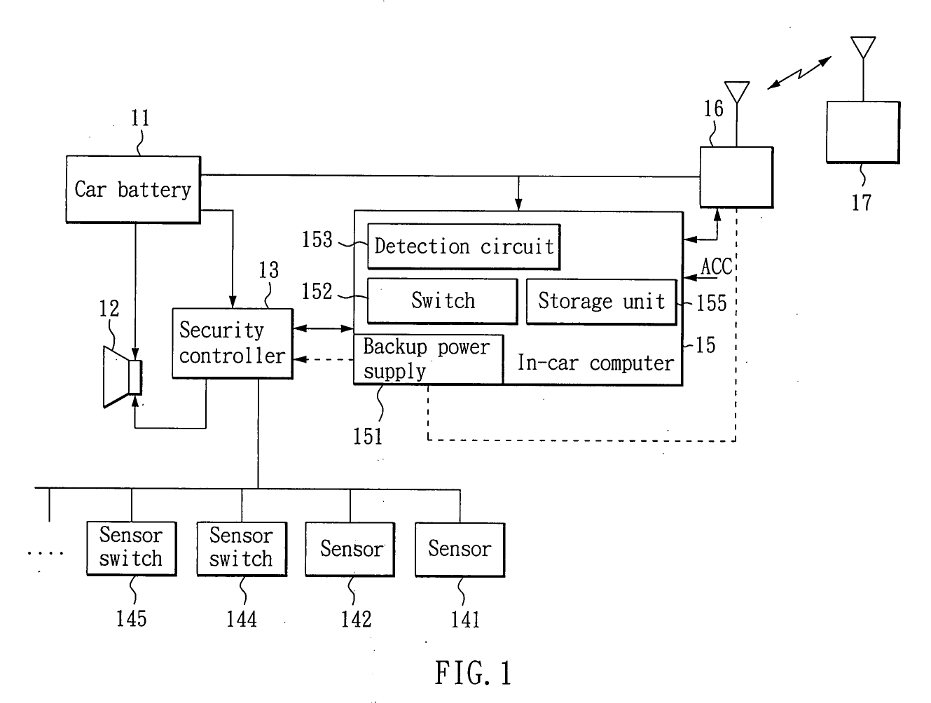

The present invention will now be described by way of example. FIG. 1 is a system block diagram according to the preferred embodiment of the present invention. As illustrated, the vehicle security system includes the car battery 11 of the car in which the vehicle system is installed, a buzzer 12, a security controller 13, sensors 141 and 142, sensor switches 144 and 145, an in-car computer 15, a wireless communication module 16, and a remote receiver 17. The in-car computer 15 includes a backup power supply 151, a switch 152, a detection circuit 153, and a storage unit 155.

The car battery 11 is electrically connected to the buzzer 12, the security controller 13, the in-car computer 15, and the wireless communication module 16 to provide these devices with the necessary working voltage for normal working. The buzzer 12, the in-car computer 15, the sensors 141 and 142, and the sensor switches 144 and 145 are respectively electrically connected to the security controller 13. Further, the connection between the security controller 13 and the in-car computer 15 is done through a data line, such as RS232.

In addition to the data line between the security controller 13 and the in-car computer 15, a power cable is provided and connected between the backup power supply 151 of the in-car computer 15 and the security controller 13. When the main electric power of the in-car computer 15 fails (for example, when the power cable between the car battery 11 and the security controller 13 has been unauthorizedly interrupted), the in-car computer 15 can utilize the backup power supply 151 to provide the necessary working voltage (backup power) to the security controller 13 for keeping the security controller 13 to function normally.

Further, a power cable is provided and connected between the backup power supply 151 of the in-car computer 15 and the wireless communication module 16. When the main electric power of the wireless communication module 16 is interrupted, the in-car computer 15 also can utilize the backup power supply 151 to provide the necessary working voltage to the wireless communication module 16 for keeping the wireless communication module 16 in a normally functioning status.

In this embodiment, the backup power supply 151 is a rechargeable storage battery that can be a nickel hydrogen battery, an Li-ion battery, a nickel chrome battery, a lithium polymer battery, or any of a variety of other storage batteries. Alternatively, the backup power supply 151 also can be an uninterrupted power supply (UPS).

Generally, under the alert mode, the security controller 13 is alerted to the occurrence of an abnormal condition through the sensors 141 and 142 and the sensor switches 144 and 145. For example, in one embodiment, the sensor 141 is a vibration sensor; the sensor 142 is a tilt sensor; the sensor switch 144 is an ignition switch detection sensor switch; and, the sensor switch 145 is an engine hood detection sensor switch.

When one of the sensors 141 and 142 or one of the sensor switches 144 and 145 is induced under the alert mode of the vehicle security system, the induced sensor immediately provides a sensing signal to the security controller 13. For example, when the engine hood is opened, the sensor switch 145 immediately provides a sensing signal to the security controller 13, causing the security controller 13 to drive the buzzer 12 to buzz, or to drive the lights of the car to flash. In another embodiment, the quantity and type of the sensors and sensor switches may be changed to fit different security requirements.

When a thief is stealing the car, he (she) may override the ignition switch of the car in a common yet unorthodox manner (for example, attaching two electric wires to the two contacts of the ignition switch to connect the circuit and to further start the engine). In this situation, although the conventional design has used the ignition switch detection sensor switch to sense whether the ignition switch has been actuated, the security controller just passively drives the buzzer to buzz.

Normally, the car owner will turn off the engine (the ignition switch) and close the car door and then operate a remote controller to activate the vehicle security system immediately after parking the car, and turning the security controller 13 into the alert mode. When the security controller 13 set in the alert mode, the detection circuit 153 provided by the present invention starts to function. The operation of the detection circuit 153 is described hereinafter.

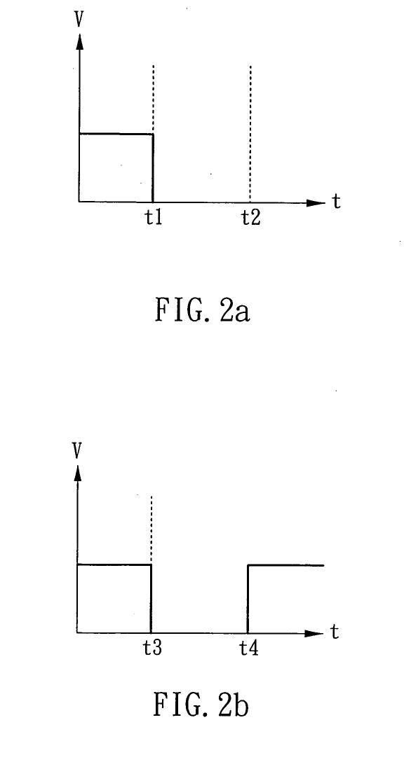

According to the preferred embodiment of the present invention, the detection circuit 153 configured in the in-car computer 15 is used for detecting the production of the ignition switched-on signal. With respect to the detailed description, please refer to FIGS. 2a and 2b. FIG. 2a is a schematic drawing showing the normal status under the alert mode. FIG. 2b is a schematic drawing showing an abnormal status under the alert mode. In FIG. 2a, the car owner leaves the car and sets the alert mode of the security controller 13 at the time t1. At this time, the security controller 13, the sensors 141 and 142, the sensor switches 144 and 145 and the detection circuit 153 start to function, and the voltage at the detection end of the detection circuit 153 is zero (meaning the ignition switch is off). When the car owner returns to the nearby place around the car and operates the remote controller to disarm the security controller 13 at the time t2, the security controller 13, the sensors 141 and 142, the sensor switches 144 and 145 and the detection circuit 153 are deactivated. Namely, the security controller 13, the sensors 141 and 142, the sensor switches 144 and 145 and the detection circuit 153 will function only when the vehicle security system set in the alert mode, and will be turned off when the vehicle security system is disarmed.

In FIG. 2b, the car owner leaves the car and operates the remote controller to set the alert mode of the security controller 13 at the time t3, driving the detection circuit 153 to detect the production of the ignition switched-on signal and transmission of the ignition switched-on signal from the ignition switch to the in-car computer 15; at the time t4, the detection circuit 153 detects an increase of the voltage at the ignition switch to a predetermined value (for example: 12V) (in other words, the ignition switched-on signal is produced and transmitted to the in-car computer 15). At this time (the time t4), the detection circuit 153 provides a first detection signal, causing the in-car computer 15 to send an informing message to the remote receiver 17 through the wireless communication module 16. With respect to the wireless communication module 16, the remote receiver 17 and the informing message, description will be provided further.

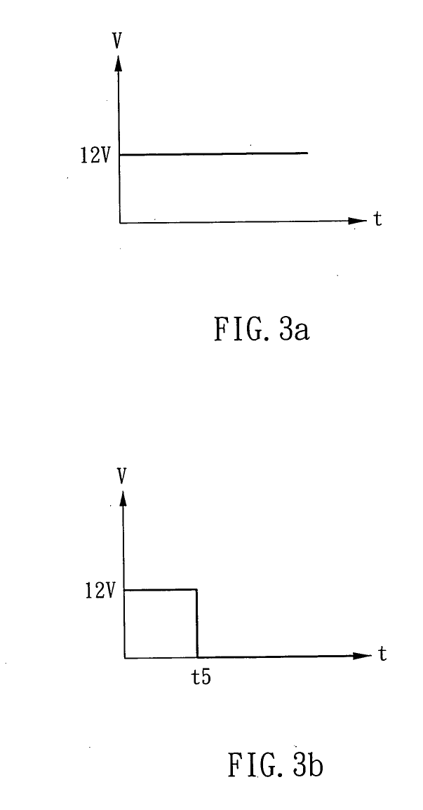

Further, in addition to the detection of the production of the ignition switched-on signal after the security controller 13 has set in the alert mode, the detection circuit 153 also detects the connection between the car battery 11 and the in-car computer 15. With respect to this regard, please refer to FIGS. 3a and 3b. FIG. 3a is a schematic drawing showing the connected normal status of the main electric power. FIG. 3b is a schematic drawing showing the disconnected abnormal status of the main electric power.

In FIG. 3a, the detection circuit 153 detects a constant 12V power voltage at the circuit between the car battery 11 and the in-car computer 15. At this time, the security status is normal, and the vehicle security system is in an idle mode.

In FIG. 3b, the detection circuit 153 detects a zero power voltage at the circuit between the car battery 11 and the in-car computer 15 at the time t5, which means that the electric power of the car battery 11 has been interrupted. At this time, the detection circuit 153 provides a second detection signal to the in-car computer 15, causing the in-car computer 15 to send an informing message to the remote receiver 17 through the wireless communication module 16.

The aforesaid second detection signal produced by the detection circuit 153 will also drive the switch 152, causing the switch 152 to switch the backup power supply 151 to the in-car computer 15 for normal operation. At this time, the backup power supply 151 provides the necessary working voltage to the security controller 13, the in-car computer 15 and the wireless communication module 16. Because of limited capacity, the backup power supply 151 can only provide limited backup power for the operation of the basic members, such as the storage unit 155 and other related elements, of the in-car computer 15 under a power-saving mode.

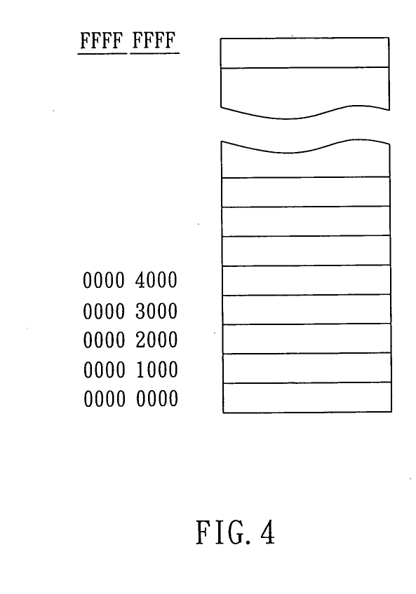

In this embodiment, the storage unit 155 of the in-car computer 15 stores a plurality of anti-thief warning events such as vibration, intrusion, tilting, or power off. The data of every anti-thief warning event is stored in the storage unit 155 subject to a different address. For example, FIG. 4 is a schematic drawing showing a storage example of the storage unit 155. As illustrated, car vibration related data is stored at address 00000000˜00001000; car intrusion related data is stored at address 00001000˜00002000; car tilting related data is stored at address 00002000˜00003000; power off related data is stored at address 00003000˜00004000.

Therefore, when the detection circuit. 153 produced the second detection signal, the in-car computer 15 accesses the related address at the storage unit 155 subject to the second detection signal received, for example, address 00003111 to fetch power off related data and to convert fetched data into a message format for further transmission to the remote receiver 17 through the wireless communication module 16.

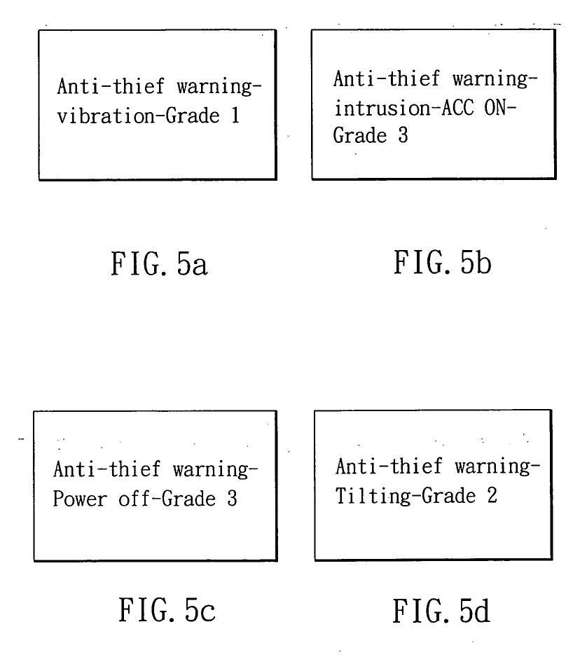

FIGS. 5a˜5d represent some representative informing message contents. For example, if the electric power provided by the car battery 11 is interrupted during the alert mode, the security controller 13 can still use the backup power provided by the backup power supply 151 to maintain basic operation. Of course, if the supply of the electric power of the car battery 11 is normal, the security controller 13 remains in basic operation.

If the sensor 141 detects a vibration of the car and subsequently produces a detection signal which is sent to the security controller 13 at this time, whereafter the security controller 13 will transfer the related status signal corresponding to the received detection signal to the in-car computer 15, causing the in-car computer 15 to fetch the corresponding data from the storage unit 155 and to send the related informing message to the remote receiver 17 via the wireless communication module 16. The content of this informing message, as shown in FIG. 5a, indicates the anti-thief warning to be “vibration” and the danger status to be “Grade 1”. In this embodiment, a higher number of the grade of the danger status indicates a relatively more severe danger status.

Similarly, the content of the informing message shown in FIG. 5b indicates the anti-thief warning to be “intrusion” and the danger status to be “Grade 3”; the content of the informing message shown in FIG. 5c, indicates the anti-thief warning to be “tilting” and the danger status to be “Grade 2”.

In this embodiment, the wireless communication module 16 is a GSM (Global System for Mobile Communication) module. Alternatively, the wireless communication module 16 can be a GPRS (General Packet Radio Service) module, WCDMA (Wideband Code Division Multiple Access) system, or any of a variety of other advanced wireless communication modules.

Further, the remote receiver can be a mobile phone carried by the owner of the car. The communication protocol adopted by the remote receiver 17 matches or is compatible to the wireless communication module 16 of the vehicle security system. Alternatively, the remote receiver 17 can be the Call Center that informs the car owner or takes the necessary step, for example, calls the police when receiving an informing message from the vehicle security system. According to the present preferred embodiment, there is only one remote receiver 17. Alternatively, the wireless communication module 16 can be driven to send the informing message to a plurality of remote receivers subject to the list of the parties to be called that is stored in the storage unit 155, for example, the wireless communication module 16 can be driven to send the informing message to the Call Center, the (mobile phone of the) car owner, and the related emergency communication parties.

In the present preferred embodiment, the informing message can be a letter message of short message format. Alternatively, the informing message can be a recorded voice message, a multimedia video file, an e-mail message, or any of a variety of equivalent messages transmittable wirelessly through the wireless communication module. In another embodiment, the informing message is a short message or e-mail message, wherein the remote receiver 17 can convert the format and send the message to another terminal device, such as a fax machine, via the Internet or a telecommunication network.

Although the present invention has been explained in relation to its preferred embodiments, it is to be understood that many other possible modifications and variations can be made without departing from the spirit and scope of the invention as hereinafter claimed.

What is claimed is:

1. A vehicle security system comprising:
a car battery for the supply of electric power;
a security controller electrically connected to the car battery and alternatively set between an alert mode and a non-alert mode;
an in-car computer electrically connected to the car battery, the in-car computer including a detection circuit and a backup power supply; and
a wireless communication module;
wherein the detection circuit detects the supply of electric power from the car battery when the security controller set in the alert mode;
wherein the backup power supply provides backup power to the in-car computer and the in-car computer controls the wireless communication module to send an informing message to at least one remote receiver when the supply of electric power from the car battery to the in-car computer is interrupted and the interruption is detected by the detection circuit.

2. The vehicle security system as claimed in claim 1, wherein the in-car computer further comprises a storage unit, the storage unit stored a plurality of anti-thief events to be selectively contained in the informing message for sending by the wireless communication module to the at least one remote receiver.

3. The vehicle security system as claimed in claim 1, wherein the detection circuit further detects the transmission of an ignition switched-on signal from an ignition switch to the in-car computer during the alert mode, and drives the in-car computer to send the informing message to the at least one remote receiver via the wireless communication module when detecting the transmission of the ignition switched-on signal from the ignition switch to the in-car computer.

4. The vehicle security system as claimed in claim 3, wherein the informing message contains information about the condition that the ignition switch has been switched on.

5. The vehicle security system as claimed in claim 1, wherein the in-car computer is electrically connected to the security controller so enabling the backup power supply to provide backup power to the security controller for operation of the security controller when the car battery is disconnected from the security controller.

6. The vehicle security system as claimed in claim 5, wherein the security controller is electrically connected to at least one sensor; the in-car computer further comprises a storage unit storing a plurality of anti-thief events; when the supply of electric power from the car battery is terminated and the at least one sensor provides a detection signal to the security controller, the security controller transmits a status signal related to the detection signal to the in-car computer to enable the in-car computer to select a corresponding anti-thief event from the storage unit based on the status signal related to the detection signal and transmit the informing message related to the corresponding anti-thief event to the at least one remote receiver via the wireless communication module.

7. The vehicle security system as claimed in claim 1, wherein the in-car computer further includes a switch device-electrically connected to the detection circuit and the backup power supply and adapted to control the supply of backup power from the backup power supply to the in-car computer; the detection circuit provides a detection signal to the switch device of the in-car computer when detecting the condition that the supply of electric power from the car battery has been terminated, the detection signal driving the switch device to switch to the backup power supply to provide the backup power to the in-car computer.

8. The vehicle security system as claimed in claim 1, wherein the backup power supply is a rechargeable battery.

9. The vehicle security system as claimed in claim 8, wherein the rechargeable battery is selected from a group of a nickel hydrogen battery, a Li-ion battery, a nickel chrome battery and a lithium polymer battery.

10. The vehicle security system as claimed in claim 1, wherein the backup power supply is an uninterrupted power supply.
